(19) United States
(12) Patent Application Publication
(10) Pub. No.: US 2024/0144369 A1
(43) Pub. Date: May 2, 2024

(54) INFORMATION PROCESSING DEVICE AND INFORMATION PROCESSING METHOD

(71) Applicant: Hitachi, Ltd., Tokyo (JP)

(72) Inventors: Yosuke Tanabe, Tokyo (JP); Ryuji Mine, Tokyo (JP); Takeshi Kato, Tokyo (JP); Koichi Watanabe, Tokyo (JP); Tsukasa Funane, Tokyo (JP)

(21) Appl. No.: 18/494,207

(22) Filed: Oct. 25, 2023

(30) Foreign Application Priority Data
Oct. 31, 2022 (JP) 2022-173999

(51) Int. Cl. G06Q 40/04

(52) U.S. Cl. CPC G06Q 40/04

(57) ABSTRACT

An information processing device includes an input unit for inputting a human influence parameter influenced by a human activity and a natural environment parameter influenced by non-human ecosystem and non-ecosystem activities, a computing unit that calculates a natural capital stock prediction value from the human influence parameter and the natural environment parameter, using a function representing an integration of an amount of change per unit time in natural capital stock, which has elements of internal factors that may change over time and external factors including the human influence parameter and the natural environment parameter, and an output unit for outputting the natural capital stock prediction value calculated by the computing unit.

### CLAIM OF PRIORITY

The present application claims priority from Japanese Patent application serial no. 2022-173999, filed on Oct. 31, 2022, the content of which is hereby incorporated by reference into this application.

### BACKGROUND OF THE INVENTION

### 1. Field of the Invention

The present disclosure relates to as information processing device and an information processing method for predicting natural capital stock.

### 2. Description of Related Art

Traditionally, in the field of economics, production is predicted using the Cobb-Douglas function, which assumes that production takes place with human capital related to an amount of labor and artificial capital related to production equipment as factors of production. However, it is self-evident that in actual production activities, in addition to the human capital and the artificial capital, various natural capital stocks such as oil, natural gas, minerals, forests, soil, and marine resources are also input as the factors of production, and methods are known for evaluating and predicting sustainable economic activity using an improved Cobb-Douglas production function that takes into account the input of natural capital stock.

In evaluating and predicting sustainable economic activities using such an improved Cobb-Douglas production function, it is necessary to consider the consumption and conservation of natural capital stocks by human activities, or the increase and decrease in natural capital stocks due to climate change and wildfires caused by the activities of non-human natural phenomena. Regarding climate change among them, techniques are known to predict the depletion of natural capital stocks due to global warming by introducing a weather model that represents the temperature rise in the atmosphere and ocean due to the effects of greenhouse gases emitted by economic activities of the humans.

Further, for example, PTL 1 (JP6147579B) discloses a method for predicting natural capital stock using a linear model or a non-linear model with solar radiation, precipitation, etc. as explanatory variables.

Meanwhile, in the related prediction of natural capital stocks described above, there is room for improvement in predicting increases and decreases in natural capital stocks due to human and non-human activities. In other words, there are time scales for increases and decreases in natural capital stocks in response to each event including, as human activities, consumption such as mining of minerals and harvesting of crops and conservation such as afforestation, and as non-human activities, depletion due to climate change or burning due to wildfires.

In the PTL 1 described above, modeling with a focus on each specific event is provided, but it does resent a technique for predicting increases and decreases in natural capital stocks on various time scales caused by these human activities and various activities of non-human natural phenomena.

### SUMMARY OF THE INVENTION

Accordingly, an object of the present disclosure is to provide an information processing device and an information processing method for predicting increases and decreases in natural capital stocks due to human activities and non-human ecosystem and non-ecosystem activities.

In order to solve the problems described above, the present disclosure includes an information processing device including an input unit for inputting a human influence parameter influenced by a human activity and a natural environment parameter influenced by non-human ecosystem and non-ecosystem activities, a computing unit that calculates a natural capital stock prediction value from the human influence parameter and the natural environment parameter, using a function representing an integration of an amount of change per unit time in natural capital stock, which has elements of internal factors that change over time and external factors including the human influence parameter and the natural environment parameter, and an output unit for outputting the natural capital stock prediction value calculated by the computing unit.

The present disclosure may also include (a) inputting a human influence parameter influenced by a human activity and a natural environment, parameter influenced by non-human ecosystem and non-ecosystem activities, (b) calculating a natural capital stock prediction value from the human influence parameter and the natural environment parameter, using a function representing an integration of an amount of change per unit time in natural capital stock, which has elements of internal factors that may change over time and external factors including the human influence parameter and the natural environment parameter, and (c) outputting the natural capital stock prediction value calculated in (b).

According to the present disclosure, it is possible to implement an information processing device and an information processing method for predicting increases and decreases in natural capital stock due to human activities and non-human ecosystem and non-ecosystem activities.

This makes it possible to predict increases and decreases in natural capital stock on various time scales caused by human activities and various activities of non-human natural phenomena, thereby improving the accuracy of production predicts.

The problems, configurations, and effects other than those described above will be clarified from the description of the embodiments below.

### BRIEF DESCRIPTION OF THE DRAWINGS

FIG. 1 is a block diagram showing a schematic configuration of an information processing device according to a first embodiment of the present disclosure;

FIG. 2 is a sequence diagram showing an operation (process) of the information processing device in FIG. 1;

FIG. 3 is a graph showing annual variation in temperature in mixed forest;

FIG. 4 is a graph showing annual variation in precipitation in mixed forest;

FIG. 5 is a graph showing annual variation in human consumption of mixed forest;

FIG. 6 is a graph comparing annual variation prediction values of a normalized vegetation index of mixed forest with and without human consumption which are predicted using the information processing device of FIG. 1;

FIG. 7 is a block diagram showing a schematic configuration of an information processing device according to a second embodiment of the present disclosure;

FIG. 8 is a sequence diagram showing an operation (process) of the information processing device in FIG. 7;

FIG. 9 is a graph showing annual variation actual measurement values in temperature in a deciduous broad-leaved forest;

FIG. 10 is a graph showing annual variation actual measurement values in precipitation in the deciduous broad-leaved forest;

FIG. 11 is a graph showing annual variation actual measurement values of a normalized vegetation index of the deciduous broad-leaved forest;

FIG. 12 is a graph comparing annual variation prediction values of the normalized vegetation index of the deciduous broad-leaved forest predicted using the information processing device of FIG. 7 and the annual variation actual measurement values;

FIG. 13 is a graph comparing annual variation prediction values of the normalized vegetation index of the deciduous broad-leaved forest predicted using a related information processing device and the annual variation actual measurement values;

FIG. 14 is a block diagram showing a schematic configuration of an information processing device according to a third embodiment of the present disclosure;

FIG. 15 is a sequence diagram showing an operation (process) of the information processing device in FIG. 14; and

FIG. 16 is a flowchart showing an information processing method according to the first embodiment of the present disclosure.

### DESCRIPTION OF EMBODIMENTS

Hereinafter, embodiments of the present disclosure will be described with reference to the drawings. In each drawing, the same or functionally same configurations are denoted by the same reference numerals, and repetitive explanations of duplicate parts are partially omitted.

In addition, “human activities” as used herein means conscious human activities (human activities), and “natural environment” means information related to ecosystems excluding non-ecosystems and conscious human activities.

### First Embodiment

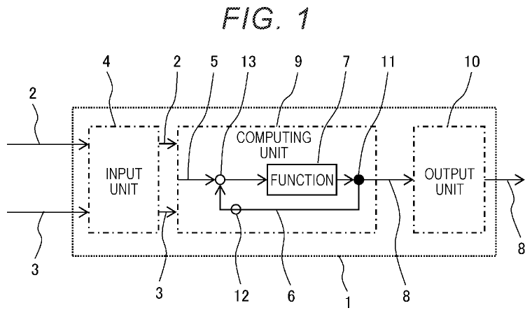

An information processing device and an information processing method according to a first embodiment of the present disclosure will be described with reference to FIGS. 1 to 6 and FIG. 16.

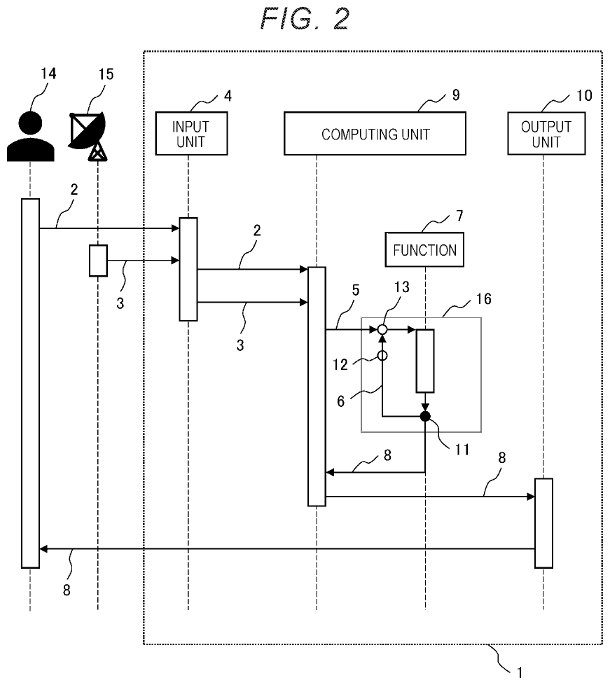

First, a schematic configuration of the information processing device of the present embodiment will be described with reference to FIGS. 1 and 2. FIG. 1 is a block diagram showing a schematic configuration of an information processing device 1 of the present embodiment. FIG. 2 is a sequence diagram showing an operation (process) of the information processing device 1 of FIG. 1.

As shown in FIG. 1, the information processing device 1 of the present embodiment includes, as main components, an input unit 4, a computing unit 9, and an output unit 10.

The input unit 4 receives, as an input, a human influence parameter 2 influenced by human activities and a natural environment parameter 3 influenced by non-human ecosystems and ecosystem activities.

The computing unit 9 calculates a natural capital stock prediction value 8 using a function 7 representing the integration of an amount of change per unit time in natural capital stock, which includes, as elements, an external factor 5 including the human influence parameter 2 and the natural environment parameter 3 input to the input unit 4 and an internal factor 6 that may change over time.

The output unit 10 outputs the natural capital stock prediction value 8 calculated by the computing unit 9 to the outside of the information processing device 1.

For example, the input unit 4 may be a keyboard, a mouse, a sensor, a connection terminal from an external device, or the like, and the output unit 10 may be, for example, a display or a connection terminal to an external device. The input unit 4 and the output unit 10 may be configured with the above input and output (I/O) devices. Further, the computing unit 9 may be configured with a Central Processing Unit (CPU) or the like.

In order to avoid numerical divergence in the computing unit 9, the function 7 has, as an element, a value obtained by adding the external factor 5 at an addition point 13 to a value obtained by assigning a negative sign 12 to the internal factor 6 branched at an extraction point 11 from the natural capital stock prediction value 8.

FIG. 2 is a diagram showing an example of an operation (process) of the information processing device 1, which is a sequence diagram of a situation when an input is given to the information processing device 1 from a user 14 and a around station antenna 15 that receives data from an artificial satellite.

First, the user 14 inputs the human influence parameter 2 related to the conservation or utilization of the natural capital stock to be considered, and the ground station antenna 15 inputs the natural environment parameter 3 based on the received satellite data related to the natural capital stock to be considered, to the input unit 4 of the information processing device 1, respectively.

Next, the input unit 4 inputs the human influence parameter 2 and the natural environment parameter 3 to the computing unit 9.

The computing unit 9 assigns the negative sign 12 to the internal factor 6 obtained by branching the natural capital stock prediction value 8 at the extraction point 11, and then adds the internal factor 6 and the external factor 5 obtained by adding the human influence parameter 2 and the natural environment parameter 3 at the addition point 13, and inputs the added value to the function 7 representing the integration of the amount of change per unit time in natural capital stock, and calculates the natural capital stock prediction value 8. The time series natural capital stock prediction value 8 is output from the computing unit 9 to the output unit 10.

Then, the output unit 10 outputs the natural capital stock prediction value 8 to the outside of the information processing device 1 (to the user 14 in FIG. 2), and the process ends.

The computation by the function 7 is in a loop 16 as long as the human influence parameter 2 and the natural environment parameter 3 are input.

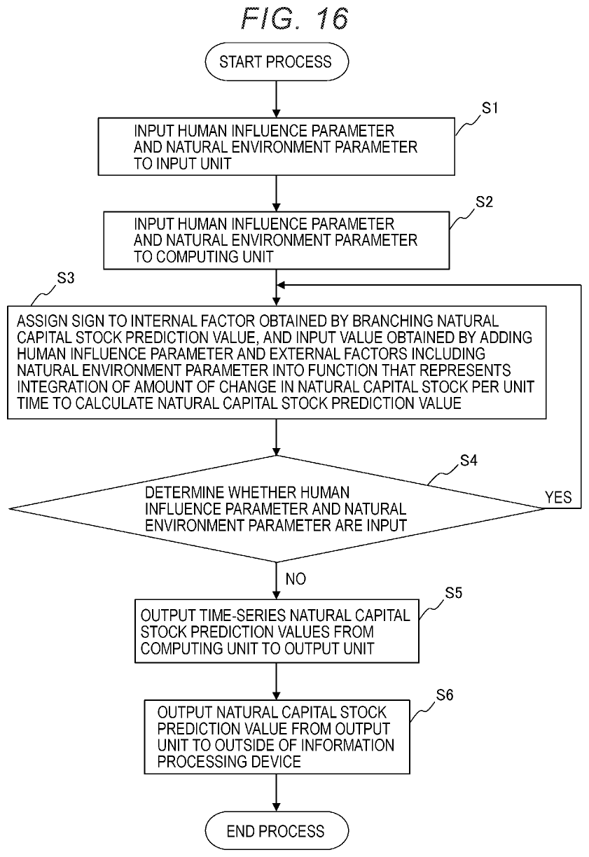

The operation (process) described above will be described in order using the flowchart of FIG. 16.

First, in step S1, the human influence parameter 2 and the natural environment parameter 3 are input to the input unit 4.

Next, in step S2, the human influence parameter 2 and the natural environment parameter 3 are input to the computing unit 9.

Next, in step S3, the negative sign 12 is given to the internal factor 6 obtained by branching the natural capital stock prediction value 8, and a value obtained by adding with the external factor 5 including the human influence parameter 2 and the natural environment parameter 3 is input to the function 7 representing the integration of the amount of change per unit time in natural capital stock, thereby calculating the natural capital stock prediction value 6.

Next, in step S4, it is determined whether or not the human influence parameter 2 and the natural environment parameter 3 are input. When there is no input of the human influence parameter 2 and the natural environment parameter 3, the process proceeds to step S5. On the other hand, when there is an input of the human influence parameter 2 and the natural environment parameter 3, the process returns to step S3 and repeats the processes of steps S3 and S4.

Next, in step S5, the time series natural capital stock prediction value 8 is output from the computing unit 9 to the output unit 10.

Finally, in step S6, the natural capital stock prediction value 8 is output from the output unit 10 to the outside of the information processing device 1, and the process ends.

As a specific example of the information processing device 1 of the present embodiment, a case will be described in which a mixed forest, which is a forest including two or more tree species, is considered as a natural capital stock. Let y(t) he the change in mixed forest stock with respect to time t, and consider temperature x1(t) and precipitation x2(t) as natural environment parameter 3, and deforestation h(t) of mixed forest as the human influence parameter 2.

Assuming that the external factor 5 is represented by the function Φ(x1(t), x2(t), h(t)) and the function representing the amount of change per unit time in natural capital stock is represented by f, the natural capital stock prediction value 8 obtained by the computing unit 9 is given by Equation (1) as the integration of the function f.

[Equation 1]

y(t)=∫f(Φ(x₁(t), x₂(t), h(t))−y(t))dt (1)

As an example, it is assumed herein that the function Φof the external factor 5 and the function f representing the amount of change per unit time in natural capital stock are represented by linear equations, respectively, and are given by Equation (2).

$$[ Equation 2 ]$$

$$\begin{matrix}f ( Φ ( {x}_{1} ( t ) , {x}_{2} ( t ) , h ( t ) ) - y ( t ) ) = \frac{1}{τ} \{ {Φ}_{1} {x}_{1} + {Φ}_{2} {x}_{2} + {Φ}_{3} h - y ( t ) \} & ( 2 )\end{matrix}$$

In Equation (2), Φ1, Φ2, and Φ3 are weights representing the function Φ of the external factors 5, and τ is a time constant representing the amount of change per unit time in the natural capital stock predict ion value 8 due to the external factor 5 and the internal factor 6.

When the time constant τ is a constant K as shown in Equation (3), the model will increase and decrease without considering the influence of the density, of natural capital stock, and when it is inversely proportional to the natural capital stock y(t), as shown in Equation (4), the model will take into consideration the competition for resources including the external factor 5 and the internal factor 6 due to the influence of the density.

$$[ Equation 3 ]$$

$$\begin{matrix}τ = K & ( 3 )\end{matrix}$$

$$[ Equation 4 ]$$

$$τ = \frac{K}{y ( t )} \qquad ( 4 )$$

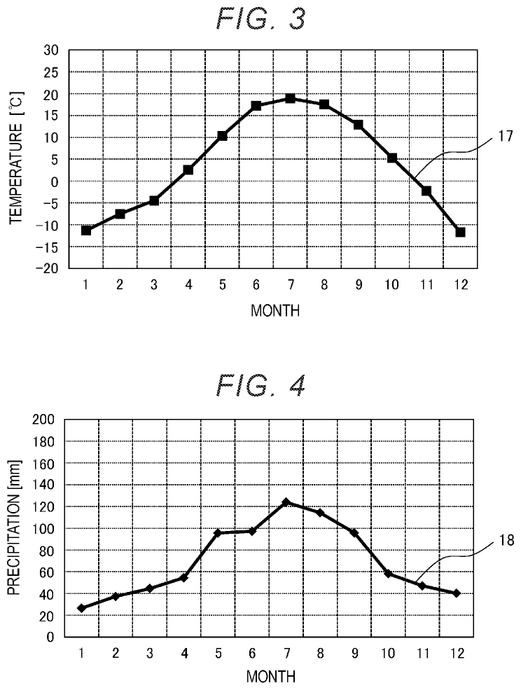

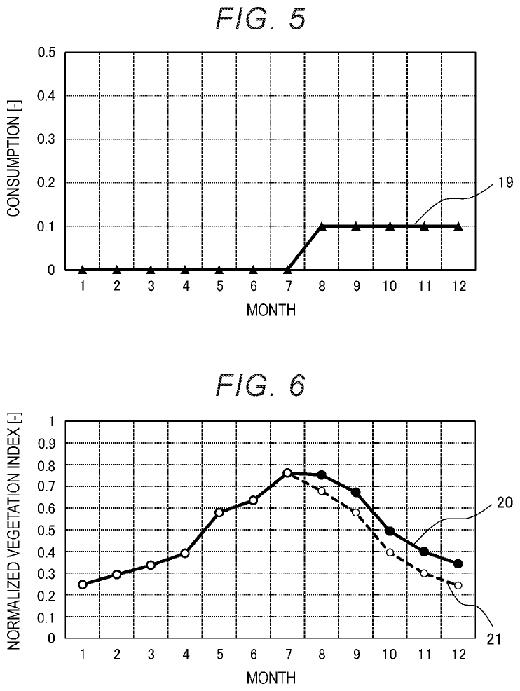

As a specific example of the natural environment parameter 3, FIG. 3 shows an annual variation 17 in the temperature of the mixed forest, and FIG. 4 shows an annual variation 18 in the precipitation in the mixed forest. As a specific example of the human influence parameter 2, FIG. 5 shows annual variation 19 in the consumption of the mixed forest. FIG. 6 shows a predicted value of an amount of mixed forest stock when these are input into the Equation (2) and the constant of the Equation (3) is assumed as the time constant τ. It is to be noted that the amount of mixed forest stock is assessed using a normalized vegetation index (NDVI).

While it is assumed herein that these natural environment parameter 3 and the human influence parameter 2 are calculated through signal processing such as principal component analysis and pattern recognition from hyperspectral data measured by a hyperspectral camera mounted on a satellite and image data captured by a high-resolution image sensor, aspects are not limited to satellites, and these parameters may also be calculated using data measured by aircraft or drones or data measured. on the ground.

FIG. 6 shows an annual variation 20 of the normalized vegetation index for mixed forest without human consumption computed with the human influence parameter 2 of zero (0), and an annual variation 21 of the normalized vegetation index for the mixed forest with human consumption computed given the human influence parameter 2 in FIG. 5.

As described above, according to the information processing device 1 of the present embodiment, the natural capital stock prediction value 8 is calculated from the human influence parameter 2 and the natural environment parameter 3 using the function 7 representing the integration of the amount of change per unit time in natural capital stock by applying, as input, the human influence parameter 2 influenced by human activity and the natural environment parameter 3 influenced by non-human ecosystem and non-ecosystem activity, and accordingly, it is possible to predict increases and decreases in natural capital caused by human activities and various activities of non-human natural phenomena and provide results.

### Second Embodiment

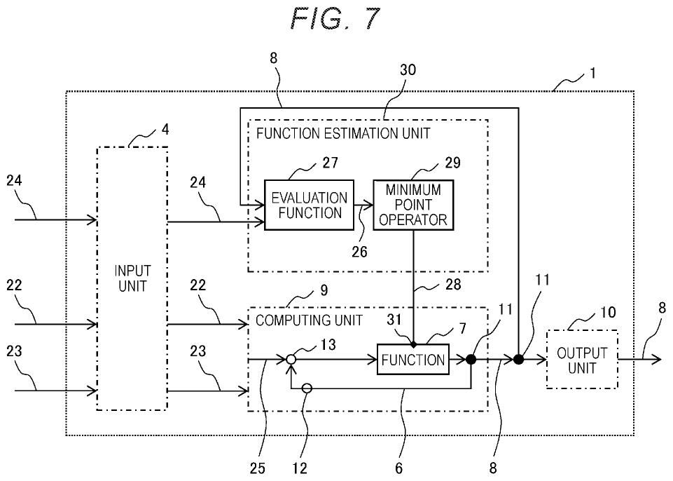

An information processing device and an information processing method according to a second embodiment of the present disclosure will be described with reference to FIG. 7 to FIG. 13.

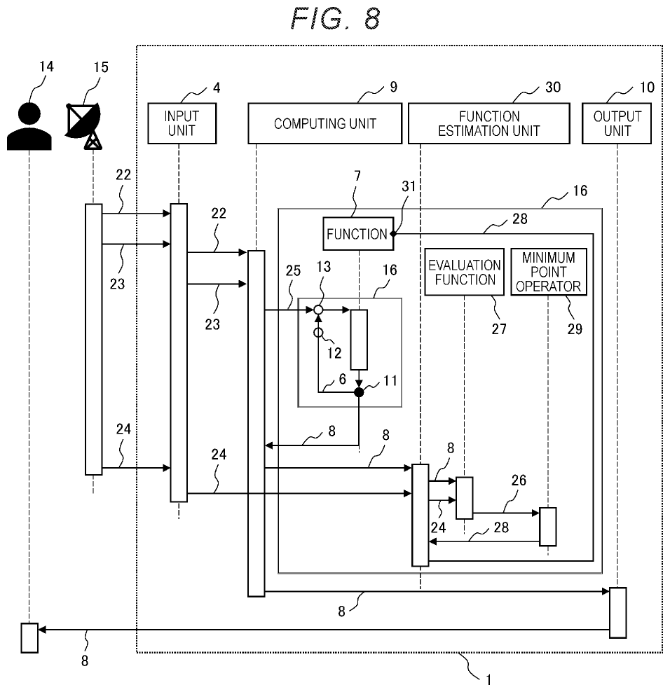

First, a schematic configuration of the information processing device of the present embodiment will be described with reference to FIGS. 7 and 8. FIG. 7 is a block diagram showing a schematic configuration of the information processing device 1 of the present embodiment. FIG. 8 is a sequence diagram showing an operation (process) of the information processing device 1 of FIG. 7.

As shown in FIG. 7, the information processing device 1 of the present embodiment includes, as main components, the input unit 4, the computing unit 9, the output unit 10, and a function estimation unit 30. The device differs from the information processing device 1 of the first embodiment (FIG. 1) in that it further includes the function estimation unit 30.

A human influence parameter actual measurement value 22 observed by a sensing means, a natural environment parameter actual measurement value 23 observed by the sensing means, and a natural capital stock actual measurement value 24 observed by the sensing means are input to the input unit 4.

The computing unit 9 calculates the natural capital stock prediction value 8 using the function 7 representing the integration of the amount of change per unit time in natural capital stock, in which the function 7 includes, as elements, an actual measured external factor 25 including the human influence parameter actual measurement value 22 and the natural environment parameter actual measurement value 23 input to the input unit 4 and the internal factor 6 that may change over time.

The function estimation unit 30 includes an evaluation function 27 that calculates an error 26 from the natural capital stock actual measurement value 24 and the natural capital stock prediction value 8, and a minimum point operator 29 that obtains a function form 28 that minimizes the error 26, and estimates the function 7 of the computing unit 9 from actual measurement values observed by the sensing means.

FIG. 8 is a diagram showing an example of the operation (process) of the information processing device 1, which is a sequence diagram of a situation when an input is given to the information processing device 1 from the ground station antenna 15 of the artificial satellite and the user 14 obtains an output from the information processing device 1.

First, the ground station antenna 15 inputs the human influence parameter actual measurement value 22, the natural environment parameter actual measurement value 23, and the natural capital stock actual measurement value 24 based on the received satellite data related to the natural capital stock to be considered, to the input unit 4 of the information processing device 1, respectively.

Next, the input unit 4 inputs the human influence parameter actual measurement value 22 and the natural environment parameter actual measurement value 23 to the computing unit 9.

The computing unit 9 assigns the negative sign 12 to the internal factor 6 obtained by branching the natural capital stock prediction value 8 at the extraction point 11, and then adds the internal factor 6 and the actual measured external factor 25 including the human influence parameter actual measurement value 22 and the natural environment parameter actual measurement value 23 at the addition point 13, and inputs the added value to the function 7 representing the integration of the amount of change per unit time in natural capital stock, and calculates the natural capital stock prediction value 8. After that, the computing unit 9 inputs the time series natural capital stock prediction value 8, and the input unit 4 inputs the natural capital stock actual measurement value 24 to the function estimation unit 30, respectively.

First, the function estimation unit 30 inputs the natural capital stock prediction value 8 and the natural capital stock actual measurement value 24 into the evaluation function 27 to calculate the error 26. Next, the error 26 is input to the minimum point operator 29 and the function form 28 that minimizes the error 26 is calculated. Finally, the function estimation unit 30 outputs the function form 28 and substitutes 31 it into the function 7 representing the integration of the amount of change per unit time in natural capital stock.

This series of function estimation processes is in the loop 16 until the error 26 is minimized. After that, the computing unit 9 inputs the natural capital stock prediction value 8 to the output unit 10, and the output unit 10 outputs the natural capital stock prediction value 8 to the outside of the information processing device 1 (to the user 14 in FIG. 8), and the process ends.

As a specific example of the information processing device 1 of the present embodiment, as in the specific example of the information processing device 1 of the first embodiment, a case in which a deciduous broad-leaved forest is considered as the natural capital stock will be described. An actual measurement value ym(t) of the change in the deciduous broad-leaved forest stock with respect to time t and a measured temperature x1m(t) and a measured precipitation X2m(t) as the natural environment parameter actual measurement value 23 are obtained by sensing by satellites, and the like. Assuming that the actual measured external factor 25 is represented by the function Φm(x1m(t), x2m(t)) and the function representing the amount of change per unit time in natural capital stock is represented by f, the natural capital stock prediction value 8 represented by y(t) obtained by the computing unit 9 is given by Equation (5).

[Equation 5]

y(t)=∫f(Φₘ(x₁ₘ(t), x₂ₘ(t))−y(t))dt (5)

Here, the function estimation unit 30 first calculates the error E, using the Equation (6), from the natural capital stock prediction value 8 obtained by Equation (5) and the actual measurement value ym(t) of the deciduous broad-leaved forest stock in the evaluation function 27.

$$[ Equation 6 ]$$

$$\begin{matrix}{E = \int {\vert y ( t ) - {y}_{m} ( t ) \vert}^{2} dt = \int \vert \int f ( {Φ}_{m} ( {x}_{1 m} ( t ) , {x}_{2 m} ( t ) ) - y ( t ) ) dt - {y}_{m} ( t ) ) \vert}^{2} dt & ( 6 )\end{matrix}$$

Next, using Equation (7), the function estimation unit 30 obtains the function f representing the amount of change per unit time in natural capital stock and the function Φm of the actual measured external factor, for a function. form that minimises the error E in Equation (6) by the minimum point operator 29.

$$[ Equation 7 ]$$

$$f , {Φ}_{m} = {argmin}_{f , {Φ}_{m}} E \qquad ( 7 )$$

In this way, the information processing device 1 of the present embodiment makes it possible to estimate the function form related to increases and decreases is natural capital stock, which is difficult to give theoretically, based on actual measurement values.

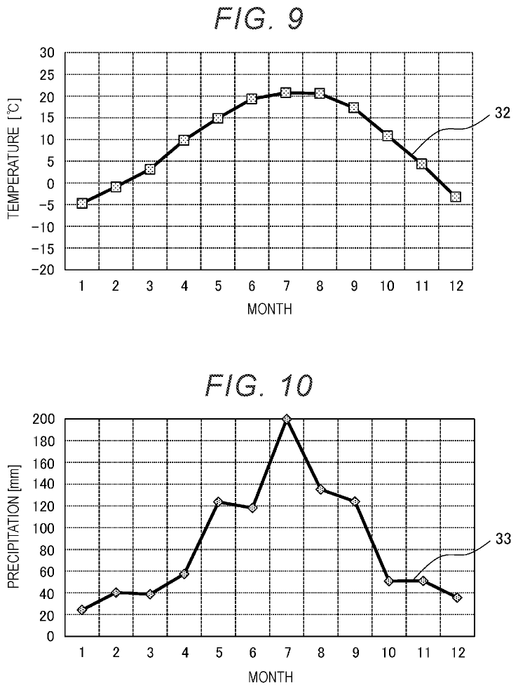

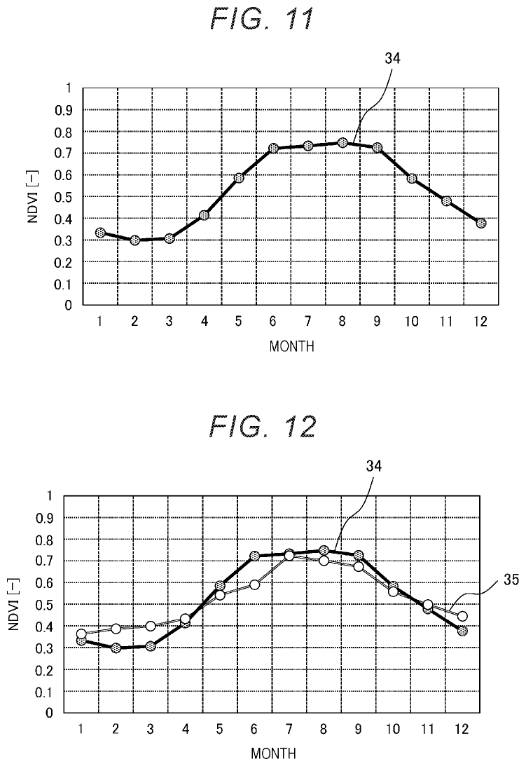

As a specific example of the natural environment parameter actual measurement value 23, FIG. 9 shows annual variation actual measurement values 32 of temperature in the deciduous broad-leaved forest, and FIG. 10 shows annual variation actual measurement values 33 of precipitation in the deciduous broad-leaved forest. In addition, as a specific example of the natural capital stock actual measurement value 24, FIG. 11 shows annual variation actual measurement values 34 of the normalized vegetation index of the deciduous broad-leaved forest.

Based on the information processing device 1 of the present embodiment, the function 7 representing the integration of the amount of change per unit time in natural capital stock that gives the natural capital stock prediction value 8 is estimated when the annual variation actual measurement values 32 of temperature and the annual variation actual measurement values 33 of precipitation are used as the actual measured external factor 25.

For the sake of simplicity, it is assumed herein that the function Φm of the actual measured external factor 25 and the function f representing the amount of change per unit time in natural capital stock are represented by linear equations, respectively, and are given by Equation (8).

$$[ Equation 8 ]$$

$$f ( {Φ}_{m} ( {x}_{1 m} ( t ) , {x}_{2 m} ( t ) ) - y ( t ) ) = \frac{1}{{τ}_{m}} \{ {Φ}_{1 m} {x}_{1 m} + {Φ}_{2 m} {x}_{2 m} - y ( t ) \} \qquad ( 8 )$$

In Equation (8), Φ1m and Φ2m are weights representing the function Φm of the actual measured external factor 25, and τm is a time constant representing the amount of change per unit time in the natural capital stock prediction value 8 due to the actual measured external factor 25 and internal factor 6.

FIG. 12 shows the results of comparison between the annual variation actual measurement values 34 of the normalized vegetation index of the deciduous broad-leaved forest and annual variation prediction values 35 of the normalized vegetation index of the deciduous broad-leaved forest calculated using the information processing device 1 of the present embodiment.

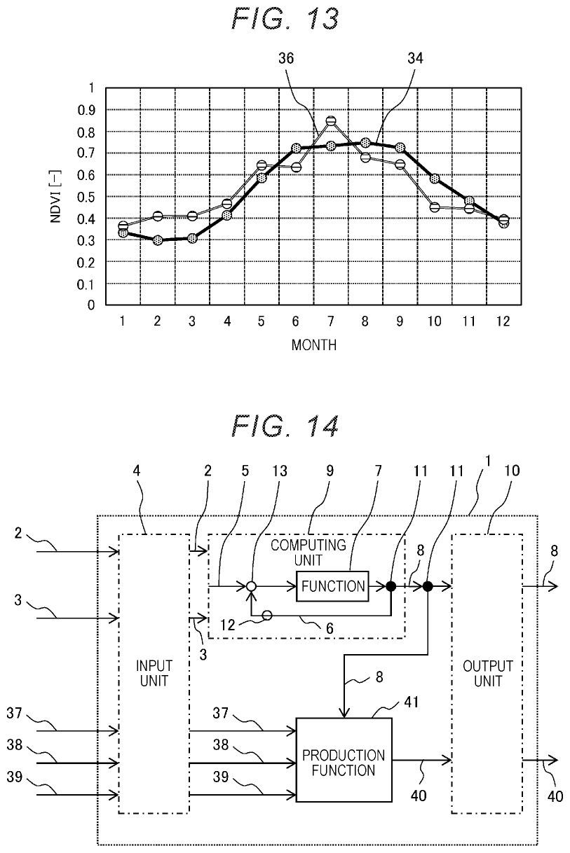

To make it easier to understand the effects of the present disclosure, FIG. 13 shows the result of prediction using only the linear model by the means disclosed in PTL 1, without using the function 7 representing the integration of the amount of change per unit time in natural capital stock. It is the result of comparison between the annual variation actual measurement values 34 of the normalized vegetation index of the deciduous broad-leaved forest and the annual variation prediction values 36 of the normalized vegetation index of the deciduous broad-leaved forest calculated using The related information processing device. It can be seen that the prediction accuracy is lower compared to the result of FIG. 12 because the time lag by the function 7 representing the integration of the amount of change per unit time in natural capital stock is not properly reflected.

As described above, the information processing device 1 of the present embodiment makes it possible to estimate the parameters representing the optimum function form that minimizes the error between the predicted value and the actual measurement value, based on the assumed function form (Equation 8 in this example).

In the example shown in Equation (8), it is assumed that the amount of change per unit time in natural capital stock is represented by a single time constant τm, but the function 7 representing the integration of the amount of change per unit time in natural capital stock may be represented using two or more time constants τmi (i=1, 2, . . . ) as shown in Equation (9).

$$[ Equation 9 ]$$

$$f ( {Φ}_{m} ( {x}_{1 m} ( t ) , {x}_{2 m} ( t ) ) - y ( t ) ) = {\sum }_{i} \frac{1}{{τ}_{mi}} \{ {Φ}_{1 mi} {x}_{1 m} + {Φ}_{2 mi} {x}_{2 m} - {y}_{i} ( t ) \} \qquad ( 9 )$$

In Equation (9), Φ1mi, Φ2mi (i=1, 2 . . . ) are weights that represent the function Φm of the actual measured external factor 25, and represent the contribution rate to the time change yi of the natural capital stock with different time scales represented by the time constant.

This makes it possible to provide prediction results of increases and decreases in natural capital stocks on various time scales caused by human activities and various activities of non-human natural phenomena.

### Third Embodiment

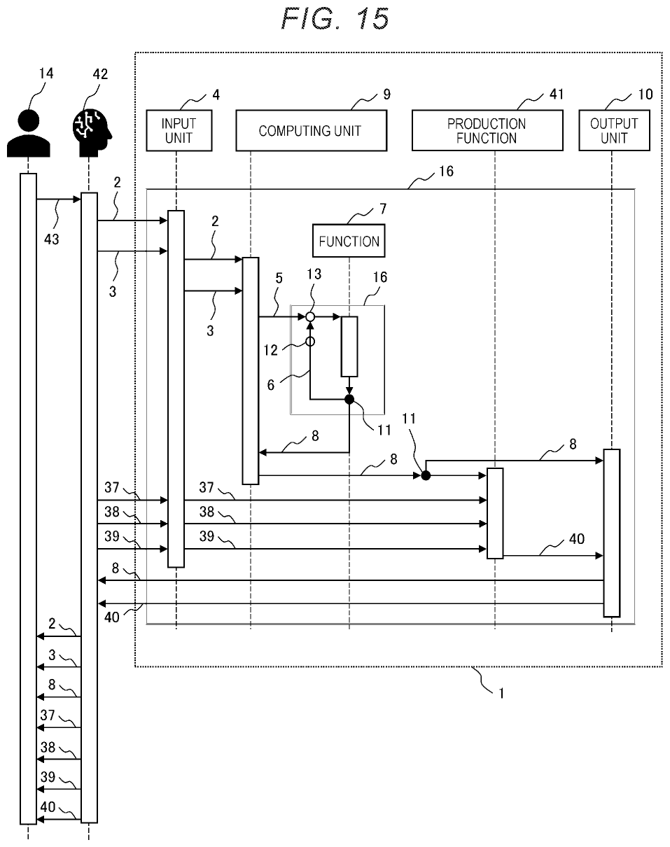

An information processing device and an information processing method according to a third embodiment of the present disclosure will be described with reference to FIGS. 14 and 15.

FIG. 14 is a block diagram showing a schematic configuration of the information processing device 1 of the present embodiment. FIG. 15 is a sequence diagram showing an operation (process) of the information processing device 1 of FIG. 14.

As shown in FIG. 14, the information processing device 1 of the present embodiment includes, as main components, the input unit 4, the computing unit 9, the output unit 10, and a production function 41. The device differs from the information processing device 1 of the first embodiment (FIG. 1) in that it further includes the production function 41.

The input unit 4 receives, as inputs, the human influence parameters 2 influenced by human activities, the natural environment parameters 3 influenced by non-human ecosystems and ecosystem activities, a human capital parameter 37 related to an amount of labor, an artificial capital parameter 38 related to production equipment, and a productivity parameter 39 related to technological and institutional innovation.

The production function 41 calculates a product output prediction value 40 obtained when the natural capital stock prediction value 8 calculated by the computing unit 9, the human capital parameter 37, the artificial capital parameter 38, and the productivity parameter 39 are applied as the factors of production.

The output unit 10 outputs the natural capital stock prediction value 8 calculated by the computing unit 9 and the product output prediction value 40 calculated by the production function 41 to the outside of the information processing device 1.

FIG. 15 is a diagram showing an example of the operation (process) of the information processing device 1, which is a sequence diagram of a situation when an input is given from an artificial intelligence 42 to the information processing device 1 to a problem presentation 43 from the user 14 to the artificial intelligence 42.

First, the artificial intelligence 42 inputs the human influence parameter 2 and the natural environment parameter 3 related to the conservation or utilization of the natural capital stock to be considered, the human capital parameter 37 related to the amount of labor required to produce products using natural capital stock, the artificial capital parameter 38 related to production equipment, and the productivity parameter 39 related to technological and institutional innovation, to the input unit 4 of the information processing device 1.

Next, the input unit 4 inputs the human influence parameter 2 and the natural environment parameter 3 to the computing unit 9.

The computing unit 9 assigns the negative sign 12 to the internal factor 6 obtained by branching the natural capital stock prediction value 8 at the extraction point 11, and then adds the internal factor 6 and the external factor 5 obtained by adding the human influence parameter 2 and the natural environment parameter 3 at the addition point 13, and inputs the added value to the function 7 representing the integration of the amount of change per unit time in natural capital stock, and calculates the natural capital stock prediction value 8. After that, the computing unit 9 inputs the natural capital stock prediction value 8 to the production function 41 and the output unit 10.

In addition to the natural capital stock prediction value 8, the human capital parameter 37, the artificial capital parameter 38 and the productivity parameter 39 are input from the input unit 4 to the production function 41.

As a result, the production function 41 calculates the product output prediction value 40 and inputs the result to the output unit 10.

The output unit 10 outputs the natural capital stock prediction value 8 and the output prediction value 40 to the outside of the information processing device 1 (to the artificial intelligence 42 in FIG. 15).

The artificial intelligence 42 adjusts the human influence parameter 2, the natural environment parameter 3, the human capital parameter 37, the artificial capital parameter 38, and the productivity parameter 39 until the presented problem is solved based on the given problem presentation 43, and inputs these parameters to the information processing device 1, and performs a computation of the loop 16.

Finally, the artificial intelligence 42 presents the human influence parameter 2, the natural environment parameter 3, the human capital parameter 37, the artificial capital parameter 38, the productivity parameter 39, the natural capital stock prediction value 8 output from the information processing device 1, and the product output prediction value 40 input to the information processing device 1 to the user 14, and the process ends.

The production function 41 is the improved Cobb-Douglas production function described above, and is given by Equation (10), where L is the human capital parameter, K is the artificial capital parameter, A is the productivity parameter, S is the natural capital stock prediction value, and Q is the output prediction value.

[Equation 10]

Q=AK^{α}^{₁}L^{α}^{₂}S^{α}^{₃} (10)

In Equation (10), α1 to α3 are values between 0 and 1, and represent the distribution ratio of factors of production to products obtained using the natural capital stock to be considered.

As explained above, the information processing device 1 of the present embodiment receives a human influence parameter influenced by a human activity and a natural environment parameter influenced by non-human ecosystem and non-ecosystem activities, a human capital parameter related to the amount of labor required to produce products using natural capital stock, an artificial capital parameter related to production equipment, and a productivity parameter related to technological and institutional innovation, to calculate the natural capital stock prediction value and the production volume prediction value, so that it is possible to predict the increase and decrease of natural capital caused by human activities and various activities of non-human natural phenomena by taking the economic influence into consideration and provide the results.

It is to be noted that the present disclosure is not limited to the embodiments described above, and includes various modifications. For example, the embodiments described above are described in detail in order to explain the present disclosure in an easy-to-understand manner, and are not necessarily limited to those having all the configurations described above. Further, a part of the configuration of an embodiment may be replaced with the configuration of another embodiment, and the configuration of another embodiment may be added to the configuration of an embodiment. In addition, it is possible to add, delete, and replace other configurations for a part of the configuration of each embodiment.

Each of the configurations, functions, processing units, processing means, and the like described above may be implemented by hardware by designing a part or all of those with, for example, an integrated circuit. Each of the configurations, functions, and the like described above may be implemented by software by interpreting and executing a program that realizes each function by the processor. Information such as a program, a table, a file, and the like that realizes each function may be stored in a recording device such as a memory, a hard disk, a solid state drive (SSD), or a recording medium such as an IC card, an SD card, DVD.

What is claimed is:

1. An information processing device comprising:
an input unit for inputting a human influence parameter influenced by a human activity and a natural environment parameter influenced by non-human ecosystem and non-ecosystem activities;
a computing unit that calculates a natural capital stock prediction value from the human influence parameter and the natural environment parameter, using a function representing an integration of an amount of change per unit time in natural capital stock, which has elements of internal factors that change over time and external factors including the human influence parameter and the natural environment parameter; and
an output unit for outputting the natural capital stock prediction value calculated by the computing unit.

2. The information processing device according to claim 1, comprising a function estimation unit that has an evaluation function and a minimum point operator and estimates the function from observed actual measurement values, wherein
the input unit is input with a human influence parameter actual measurement value, a natural environment parameter actual measurement value, and a natural capital stock actual measurement value, which are observed in advance,
the evaluation function calculates an error between the natural capital stock prediction value, which is calculated by inputting the human influence parameter actual measurement value and the natural environment parameter actual measurement value into the computing unit, and the natural capital stock actual measurement value, so that the error is minimized, and
the minimum point operator minimizes the output of the evaluation function.

3. The information processing device according to claim 1, comprising a production function for computing an output prediction value of a product obtained when applying the natural capital stock prediction value, a human capital parameter related to an amount of labor, an artificial capital parameter related to production equipment, and a productivity parameter related to technological or institutional innovation as factors of production.

4. An information processing method comprising:
(a) inputting a human influence parameter influenced by a human activity and a natural environment parameter influenced by non-human ecosystem and non-ecosystem activities;
(b) calculating a natural capital stock prediction value from the human influence parameter and the natural environment parameter, using a function representing an integration of an amount of change per unit time in natural capital stock, which has elements of internal factors that may change over time and external factors including the human influence parameter and the natural environment parameter; and
(c) outputting the natural capital stock prediction value calculated in (b).

5. The information processing method according to claim 4, comprising:
(d) inputting a human influence parameter actual measurement value, a natural environment parameter actual measurement value, and a natural capital stock actual measurement value, which are observed in advance; and
(e) calculating an error between the natural capital stock prediction value, which is calculated from the human influence parameter actual measurement value and the natural environment parameter actual measurement value, and the natural capital stock actual measurement value so that the error is minimized.

6. The information processing method according to claim 4, comprising (f) computing as output prediction value of a product obtained when applying the natural capital stock prediction value, a human capital parameter related to an amount of labor, an artificial capital parameter related to production equipment, and a productivity parameter related to technological or institutional innovation as factors of production.
